(19) United States
(12) Patent Application Publication
(10) Pub. No.: US 2023/0376908 A1
(43) Pub. Date: Nov. 23, 2023

(54) MULTI-TASK DEEP LEARNING OF EMPLOYER-PROVIDED BENEFIT PLANS

(71) Applicant: ADP, Inc., ROSELAND, NJ (US)

(72) Inventors: Leonardo Santos, Porto Alegre (BR); Alex Ferreira, Porto Alegre (BR); Eduardo Cardoso, Porto Alegre (BR); Mariele Fontana, Porto Alegre (BR); Fabio Neukirchen, Porto Alegre (BR); Edison Lima, Porto Alegre (BR)

(73) Assignee: ADP, Inc., ROSELAND, NJ (US)

(21) Appl. No.: 18/200,461

(22) Filed: May 22, 2023

Related U.S. Application Data
(63) Continuation of application No. 16/806,848, filed on Mar. 2, 2020, now abandoned.

(51) Int. Cl. G06Q 10/1057; G06Q 10/067; G06Q 40/08; G06Q 10/04; G06Q 40/06; G06N 3/044

(52) U.S. Cl. CPC G06Q 10/1057; G06Q 10/067; G06Q 40/08; G06Q 10/04; G06Q 40/06; G06N 3/044

(57) ABSTRACT

A method for generating an employee benefit plan. The process collects employment data about employees of a plurality of business entities. The employment data comprises a number of dimensions of data collected from a number of sources. The process identifies a number of plan benefits for benefit plan for each of the business entities. The process determines metrics for the plan benefits during a given time interval. The process simultaneously models the plan benefits and the metrics for plan benefits to identify correlations among the dimensions of data and generalize rules for competitive benefit prediction. According to the modeling, the process predicts a number of competitive benefits for an employee benefit plan of a particular business entity based on the employment data of the particular business entity. The process generates the employee benefit plan for the particular business entity based on the number of competitive benefits.

### CROSS-REFERENCE TO RELATED APPLICATIONS

This application claims priority and benefit under 35 U.S.C. § 120 as a continuation of U.S. Ser. No. 16/806,848, filed Mar. 2, 2020, the contents of which are hereby incorporated by reference herein in entirety.

### BACKGROUND INFORMATION

### 1. Field

The present disclosure relates generally to an improved computer system and, in particular, to deep machine learning regarding changes in employer-provided benefit plans and predicting the types of changes employers will make to plan benefits as well as when they will make them.

### 2. Background

An employer provides employee benefits to its employees according to a benefits plan that includes different types of plans for the various employees. For example, an employer may provide health insurance to its employees based on an insurance plan that is offered at different rates to the various employees. As one specific example, a particular insurance plan may be offered at a first rate for an individual employee, a second rate for an employee and the employee's spouse, a third rate for an employee and the employee's children, and a fourth rate for an employee and the employee's entire family including spouse and children.

Insurance plans can be complex and many insurance providers provide a variety of insurance plans from which an employer can choose. For example, without limitation, insurance plans may vary based on whether the coverage is limited to a Health Maintenance Organization (HMO) or a Preferred Provider Organization (PPO). As another example, insurance plans may vary based on deductibles, the percentage of carrier coinsurance, the percentage of member coinsurance, and other features.

Further, different employers choose to pay for different percentages of the insurance premiums required by insurance providers. These percentages may be different across different markets or different industries. Knowing these percentages can help an employer in determining what percentage of the overall insurance premium to pay in order to be competitive in the marketplace with respect to employee benefits.

Thus, there may be many considerations for the employer to take into account when selecting a benefits plan for its employees. However, accessing the information needed to make a well-informed selection may be more tedious, difficult, and time-consuming than desired. In some cases, this information may not be readily available or easily acquirable.

### SUMMARY

An illustrative embodiment provides a computer-implemented method for generating an employee benefit plan by using machine learning. The process collects employment data about employees of a plurality of business entities. The employment data comprises a number of dimensions of data collected from a number of sources. The process identifies a number of plan benefits for benefit plan for each of the business entities. The process determines metrics for the plan benefits during a given time interval. The process simultaneously models the plan benefits and the metrics for plan benefits to identify correlations among the dimensions of data and generalize rules for competitive benefit prediction. According to the modeling, the process predicts a number of competitive benefits for an employee benefit plan of a particular business entity based on the employment data of the particular business entity. The process generates the employee benefit plan for the particular business entity based on the number of competitive benefits.

Another illustrative embodiment provides a system for generating an employee benefit plan. The system comprises a bus system, a storage device connected to the bus system, wherein the storage device stores program instructions, and a number of processors connected to the bus system, wherein the number of processors execute the program instructions to: collect employment data about employees of a plurality of business entities, wherein the employment data comprises a number of dimensions of data collected from a number of sources; identify a number of plan benefits for benefit plan for each of the business entities; determine metrics for the plan benefits during a given time interval; simultaneously model the plan benefits and the metrics for plan benefits to identify correlations among the dimensions of data and generalize rules for competitive benefit prediction; according to the modeling, predict a number of competitive benefits for an employee benefit plan of a particular business entity based on the employment data of the particular business entity; and generate the employee benefit plan for the particular business entity based on the number of competitive benefits.

Another illustrative embodiment provides a computer program product for generating an employee benefit plan. The computer program product comprises a non-volatile computer readable storage medium having program instructions embodied therewith, the program instructions executable by a number of processors to cause the computer to perform the steps of: collecting employment data about employees of a plurality of business entities, wherein the employment data comprises a number of dimensions of data collected from a number of sources; identifying a number of plan benefits for benefit plan for each of the business entities; determining metrics for the plan benefits during a given time interval; simultaneously modeling the plan benefits and the metrics for plan benefits to identify correlations among the dimensions of data and generalize rules for competitive benefit prediction; according to the modeling, predicting a number of competitive benefits for an employee benefit plan of a particular business entity based on the employment data of the particular business entity; and generating the employee benefit plan for the particular business entity based on the number of competitive benefits.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a pictorial representation of a network of data processing systems in which illustrative embodiments may be implemented;

FIG. 2 is an illustration of a block diagram of a computer system for predictive modeling in accordance with an illustrative embodiment;

FIG. 3 is a diagram that illustrates a node in a neural network in which illustrative embodiments can be implemented;

FIG. 4 is a diagram illustrating a neural network in which illustrative embodiments can be implemented;

FIG. 5 illustrates an example of a recurrent neural network in which illustrative embodiments can be implemented;

FIG. 6 depicts a multimodal, multi-task deep learning architecture in accordance with illustrative embodiments;

FIG. 7 depicts a flowchart illustrating a process for machine learning in accordance with illustrative embodiments;

FIG. 8 depicts a flowchart for a process of predicting changes in employee benefits and generating an employee benefit plan in accordance with illustrative embodiments; and

FIG. 9 is an illustration of a block diagram of a data processing system in accordance with an illustrative embodiment.

### DETAILED DESCRIPTION

The illustrative embodiments recognize and take into account one or more different considerations. For example, the illustrative embodiments recognize and take into account that employers often provide a package of benefits to employees as part of their employment compensation.

Illustrative embodiments also recognize and take into account that the design, creation, and customization of benefit plans is a very people-centric, insight-based, human-interaction-driven process. Typically, benefit planning depends solely on the knowledge of the plan provider, without access to centralized aggregated data. Negotiation with different benefit providers, clients, agencies, and unions increases the time and energy spent to ensure that plan benefits comply with complex regulations of different relevant regulatory agencies.

Illustrative embodiments also recognize and take into account that a competitive benefit plan can be predicted from employment data over time by using deep machine learning techniques. This prediction includes not only the type of benefit that is most attractive to a customer, but also trending benefits provided by different employers. Given such predictions, proactive activities can be undertaken to meet anticipated changes in plan benefits including generating a benefit plan that is competitive with plans offered by other employers within a particular demographic.

Illustrative embodiments provide a computer-implemented method for generating an employee benefit plan by using machine learning. The process collects employment data about employees of a plurality of business entities. The employment data comprises a number of dimensions of data collected from a number of sources. The process identifies a number of plan benefits for benefit plan for each of the business entities. The process determines metrics for the plan benefits during a given time interval. The process simultaneously models the plan benefits and the metrics for plan benefits to identify correlations among the dimensions of data and generalize rules for competitive benefit prediction. According to the modeling, the process predicts a number of competitive benefits for an employee benefit plan of a particular business entity based on the employment data of the particular business entity. The process generates the employee benefit plan for the particular business entity based on the number of competitive benefits.

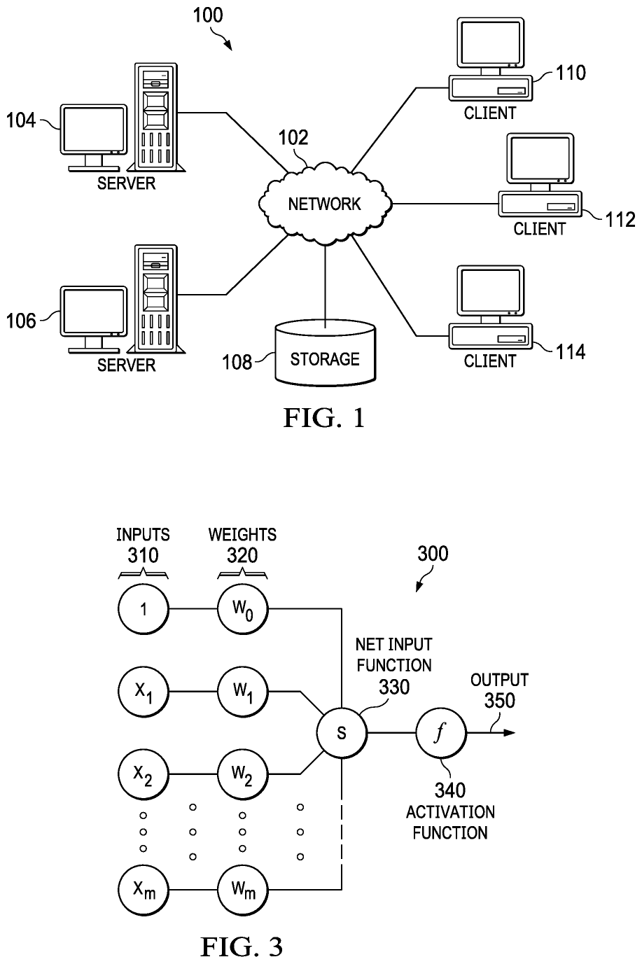

With reference now to the figures and, in particular, with reference to FIG. 1, an illustration of a diagram of a data processing environment is depicted in accordance with an illustrative embodiment. It should be appreciated that FIG. 1 is only provided as an illustration of one implementation and is not intended to imply any limitation with regard to the environments in which the different embodiments may be implemented. Many modifications to the depicted environments may be made.

The computer-readable program instructions may also be loaded onto a computer, a programmable data processing apparatus, or other device to cause a series of operational steps to be performed on the computer, a programmable apparatus, or other device to produce a computer implemented process, such that the instructions which execute on the computer, the programmable apparatus, or the other device implement the functions and/or acts specified in the flowchart and/or block diagram block or blocks.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is a medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, customer computers include client computer 110, client computer 112, and client computer 114. Client computer 110, client computer 112, and client computer 114 connect to network 102. These connections can be wireless or wired connections depending on the implementation. Client computer 110, client computer 112, and client computer 114 may be, for example, personal computers or network computers. In the depicted example, server computer 104 provides information, such as boot files, operating system images, and applications to client computer 110, client computer 112, and client computer 114. Client computer 110, client computer 112, and client computer 114 are clients to server computer 104 in this example. Network data processing system 100 may include additional server computers, client computers, and other devices not shown.

Program code located in network data processing system 100 may be stored on a computer-recordable storage medium and downloaded to a data processing system or other device for use. For example, the program code may be stored on a computer-recordable storage medium on server computer 104 and downloaded to client computer 110 over network 102 for use on client computer 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented as a number of different types of networks, such as, for example, an intranet, a local area network (LAN), or a wide area network (WAN). FIG. 1 is intended as an example, and not as an architectural limitation for the different illustrative embodiments.

The illustration of network data processing system 100 is not meant to limit the manner in which other illustrative embodiments can be implemented. For example, other client computers may be used in addition to or in place of client computer 110, client computer 112, and client computer 114 as depicted in FIG. 1. For example, client computer 110, client computer 112, and client computer 114 may include a tablet computer, a laptop computer, a bus with a vehicle computer, and other suitable types of clients.

In the illustrative examples, the hardware may take the form of a circuit system, an integrated circuit, an application-specific integrated circuit (ASIC), a programmable logic device, or some other suitable type of hardware configured to perform a number of operations. With a programmable logic device, the device may be configured to perform the number of operations. The device may be reconfigured at a later time or may be permanently configured to perform the number of operations. Programmable logic devices include, for example, a programmable logic array, programmable array logic, a field programmable logic array, a field programmable gate array, and other suitable hardware devices. Additionally, the processes may be implemented in organic components integrated with inorganic components and may be comprised entirely of organic components, excluding a human being. For example, the processes may be implemented as circuits in organic semiconductors.

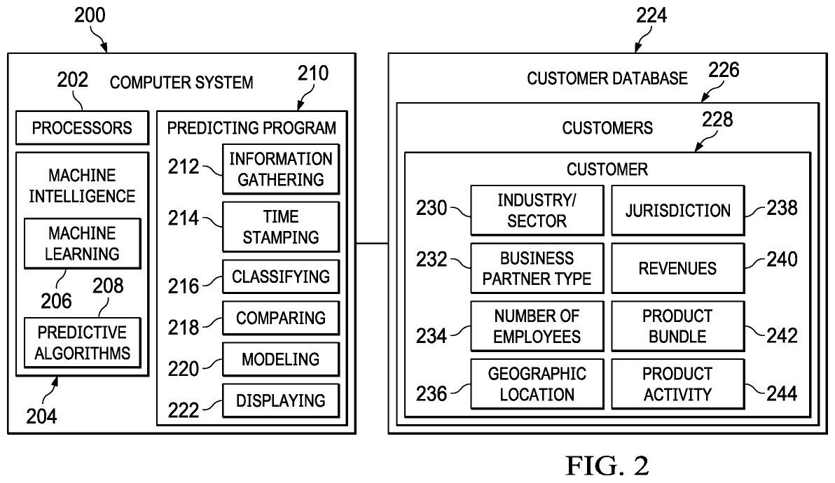

Turning to FIG. 2, a block diagram of a computer system for predictive modeling is depicted in accordance with an illustrative embodiment. Computer system 200 is connected to one or more database 224. Computer system 200 might be an example of server computer 106 in FIG. 1. Similarly, database 224 be implemented in storage such as storage unit 108 in FIG. 1.

Database 224 comprises employment data about employees of a plurality of business entities. For example, the employment data can include organizational characteristics about the plurality of business entities. Organizational characteristics can include characteristics such as, but not limited to, a payroll services beginning date, a payroll services ending date, an industry of the organization, a sub-industry of the organization, a geographic region of the organization, a number of employees of the organization, a Collection of Job Codes of the organization, a Range of Salary Amounts of the organization, and a Range of Part-Time to Full-Time Employees of the organization, as well as other suitable characteristics.

The employment data can include data generated in providing services to the one or more employees. For example, the employment data can the data such as, but not limited to, at least one of hiring, benefits administration, payroll, performance reviews, forming teams for new products, assigning research projects, or other data related to services provided to benefit employees.

The employment data can be accessed or aggregated from one or more different source databases. In this manner, database 224 may comprise one or more different databases. In one or more illustrative examples, a database may be maintained by a human capital management service provider, containing client data for the different organizations, benefit plan setup data for services provided by the service provider, employee data collected in providing human capital management services.

In one illustrative example, a database may include human capital management analytics data that relate to employees of different organizations. The data analytics may include, for example, but not limited to, at least one of attrition metrics, stability and experience metrics, employee equity metrics, organization metrics, workforce metrics, and compensation metrics, as well as other relevant metrics.

In one or more illustrative examples, a database may include publicly available information about employees of a plurality of business entities. This publicly available information may include, for example, regional wages 278, industry/sector wages 280, metropolitan statistical area (MSA) code 282, North American Industry Classification System (NAICS) code 284, Bureau of Labor Statistics (BLS) (or equivalent) 286, and census data 288.

Computer system 200 comprises information a number of processors 202, machine intelligence 204, and predicting program 210. Machine intelligence 204 comprises machine learning 206 and predictive algorithms 208.

Machine intelligence 204 can be implemented using one or more systems such as an artificial intelligence system, a neural network, a Bayesian network, an expert system, a fuzzy logic system, a genetic algorithm, or other suitable types of systems. Machine learning 206 and predictive algorithms 208 can make computer system 200 a special purpose computer for dynamic predictive modelling.

In an embodiment, processors 202 comprises one or more conventional general-purpose central processing units (CPUs). In an alternate embodiment, processors 202 comprises one or more graphical processing units (GPUs). Though originally designed to accelerate the creation of images with millions of pixels whose frames need to be continually recalculated to display output in less than a second, GPUs are particularly well suited to machine learning. Their specialized parallel processing architecture allows them to perform many more floating-point operations per second then a CPU, on the order of 100× more. GPUs can be clustered together to run neural networks comprising hundreds of millions of connection nodes. Processors can also comprise a multicore processor, a physics processing unit (PPU), a digital signal processor (DSP), a network processor, or some other suitable type of processor. Further processors 202 can be homogenous or heterogeneous. For example, processors 202 can be central processing units. In another example, processors 202 can be a mix of central processing units and graphical processing units.

Predicting program 210 comprises information gathering 212, time stamping 214, classifying 216, comparing 218, modeling 220, and displaying 222. Information gathering 252 comprises internal 254 and external 256.

There are three main categories of machine learning: supervised, unsupervised, and reinforcement learning. Supervised machine learning comprises providing the machine with training data and the correct output value of the data. During supervised learning the values for the output are provided along with the training data (labeled dataset) for the model building process. The algorithm, through trial and error, deciphers the patterns that exist between the input training data and the known output values to create a model that can reproduce the same underlying rules with new data. Examples of supervised learning algorithms include regression analysis, decision trees, k-nearest neighbors, neural networks, and support vector machines.

If unsupervised learning is used, not all of the variables and data patterns are labeled, forcing the machine to discover hidden patterns and create labels on its own through the use of unsupervised learning algorithms. Unsupervised learning has the advantage of discovering patterns in the data with no need for labeled datasets. Examples of algorithms used in unsupervised machine learning include k-means clustering, association analysis, and descending clustering.

Whereas supervised and unsupervised methods learn from a dataset, reinforcement learning methods learn from feedback to re-learn/retrain the models. Algorithms are used to train the predictive model through interacting with the environment using measurable performance criteria.

FIG. 3 is a diagram that illustrates a node in a neural network in which illustrative embodiments can be implemented. Node 300 might comprise part of machine intelligence 204 in FIG. 2. Node 300 combines multiple inputs 310 from other nodes. Each input 310 is multiplied by a respective weight 320 that either amplifies or dampens that input, thereby assigning significance to each input for the task the algorithm is trying to learn. The weighted inputs are collected by a net input function 330 and then passed through an activation function 340 to determine the output 350. The connections between nodes are called edges. The respective weights of nodes and edges might change as learning proceeds, increasing or decreasing the weight of the respective signals at an edge. A node might only send a signal if the aggregate input signal exceeds a predefined threshold. Pairing adjustable weights with input features is how significance is assigned to those features with regard to how the network classifies and clusters input data.

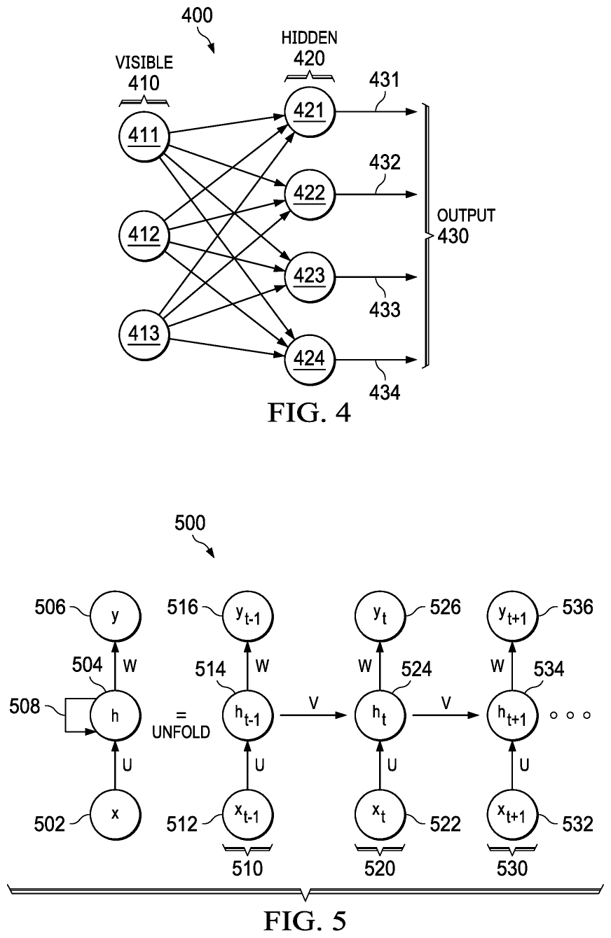

FIG. 4 is a diagram illustrating a neural network in which illustrative embodiments can be implemented. Neural network 400 might comprise part of machine intelligence 204 in FIG. 2 and is comprised of a number of nodes, such as node 300 in FIG. 3. As shown in FIG. 4, the nodes in the neural network 400 are divided into a layer of visible nodes 410, a hidden layer 420 of hidden nodes, and a layer of node outputs 430. Neural network 400 is an example of a fully connected neural network (FCNN) in which each node in a layer is connect to all of the nodes in an adjacent layer, but nodes within the same layer share no connections.

The visible nodes 410 are those that receive information from the environment (i.e. a set of external training data). Each visible node in layer 410 takes a low-level feature from an item in the dataset and passes it to the hidden nodes in the hidden layer 420. When a node in the hidden layer 420 receives an input value x from a visible node in layer 410 it multiplies x by the weight assigned to that connection (edge) and adds it to a bias b. The result of these two operations is then fed into an activation function which produces the node's output.

For example, when node 421 receives input from all of the visible nodes 411-413 each x value from the separate nodes is multiplied by its respective weight, and all of the products are summed. The summed products are then added to the hidden layer bias, and the result is passed through the activation function to produce output 431. A similar process is repeated at hidden nodes 422-424 to produce respective outputs 432-434. In the case of a deeper neural network, the outputs 430 of hidden layer 420 serve as inputs to the next hidden layer.

The outputs 430 is used to output density parameters. For example, the mean and variance for the Gaussian distribution. Usually, the FCNN is used to produce classification labels or regression values. However, the illustrative embodiments use it directly to produce the distribution parameters, which can be used to estimate the likelihood/probability of output events/time. The illustrative embodiments use the FCNN to output distribution parameters, which are used to generate the employee benefit plan.

Training a neural network is conducted with standard mini-batch stochastic gradient descent-based approaches, where the gradient is calculated with the standard backpropagation procedure. In addition to the neural network parameters, which need to be optimized during the learning procedure, there are the weights for different distributions, which also need to be optimized based on the underlying dataset. Since the weights are non-negative, they are mapped to the range [0, 1] while simultaneously requiring them summed to be 1.

In machine learning, a cost function estimates how the model is performing. It is a measure of how wrong the model is in terms of its ability to estimate the relationship between input x and output y. This is expressed as a difference or distance between the predicted value and the actual value. The cost function (i.e. loss or error) can be estimated by iteratively running the model to compare estimated predictions against known values of y during supervised learning. The objective of a machine learning model, therefore, is to find parameters, weights, or a structure that minimizes the cost function.

Gradient descent is an optimization algorithm that attempts to find a local or global minima of a function, thereby enabling the model to learn the gradient or direction that the model should take in order to reduce errors. As the model iterates, it gradually converges towards a minimum where further tweaks to the parameters produce little or zero changes in the loss. At this point the model has optimized the weights such that they minimize the cost function.

Neural networks are often aggregated into layers, with different layers performing different kinds of transformations on their respective inputs. A node layer is a row of nodes that turn on or off as input is fed through the network. Signals travel from the first (input) layer to the last (output) layer, passing through any layers in between. Each layer's output acts as the next layer's input.

Neural networks can be stacked to create deep networks. After training one neural net, the activities of its hidden nodes can be used as input training data for a higher level, thereby allowing stacking of neural networks. Such stacking makes it possible to efficiently train several layers of hidden nodes.

A recurrent neural network (RNN) is a type of deep neural network in which the nodes are formed along a temporal sequence. RNNs exhibit temporal dynamic behavior, meaning they model behavior that varies over time.

FIG. 5 illustrates an example of a recurrent neural network in which illustrative embodiments can be implemented. RNN 500 might comprise part of machine intelligence 204 in FIG. 2. RNNs are recurrent because they perform the same task for every element of a sequence, with the output being depended on the previous computations. RNNs can be thought of as multiple copies of the same network, in which each copy passes a message to a successor. Whereas traditional neural networks process inputs independently, starting from scratch with each new input, RNNs persistence information from a previous input that informs processing of the next input in a sequence.

RNN 500 comprises an input vector 502, a hidden layer 504, and an output vector 506. RNN 500 also comprises loop 508 that allows information to persist from one input vector to the next. RNN 500 can be “unfolded” (or “unrolled”) into a chain of layers, e.g., 510, 520, 530 to write out RNN 500 for a complete sequence. Unlike a traditional neural network, which uses different weights at each layer, RNN 500 shares the same weights U, W, V across all steps. By providing the same weights and biases to all the layers 510, 520, 530, RNN 500 converts the independent activations into dependent activations.

The input vector 512 at time step t−1 is xₜ₋₁. The hidden state hₜ₋₁ 514 at time step t−1, which is required to calculate the first hidden state, is typically initialized to all zeroes. The output vector 516 at time step t−1 is yₜ₋₁ Because of persistence in the network, at the next time step t, the hidden state hₜ of the layer 520 is calculated based on the hidden state hₜ₋₁ 514 and the new input vector xₜ 522. The hidden state hₜ acts as the “memory” of the network. Therefore, output yₜ 526 at time step t depends on the calculation at time step t−1. Similarly, output yₜ₊₁ 536 at time step t+1 depends on hidden state hₜ₊₁ 534, calculated from hidden state hₜ 524 and input vector xₜ₊₁ 532.

There are several variants of RNNs such as “vanilla” RNNs, Long Short-Term Memory (LSTM), Gated Recurrent Unit (GRU), and others with which the illustrative embodiments can be implemented.

By employing an RNN, the illustrative embodiments are able to model benefit plans for different employers based on benefit plans of other relevant entities and changes to those plans over time. For example, illustrative embodiments extract useful static and dynamic features based on different timestamps, which are chained together based on the natural order of timestamps for each customer. Static features (attributes) comprise features that most likely will not change at different timestamps for the same business entity such as, e.g., industry or sector, geographic location, business partner type, etc. Dynamic features comprise features that are likely to change across timestamps for a given business entity. The sequential data (both of descriptive features and outputs) can be fed into an RNN-style model to learn deep representations. For such a representation learning, the illustrative embodiments can stack multiple layers.

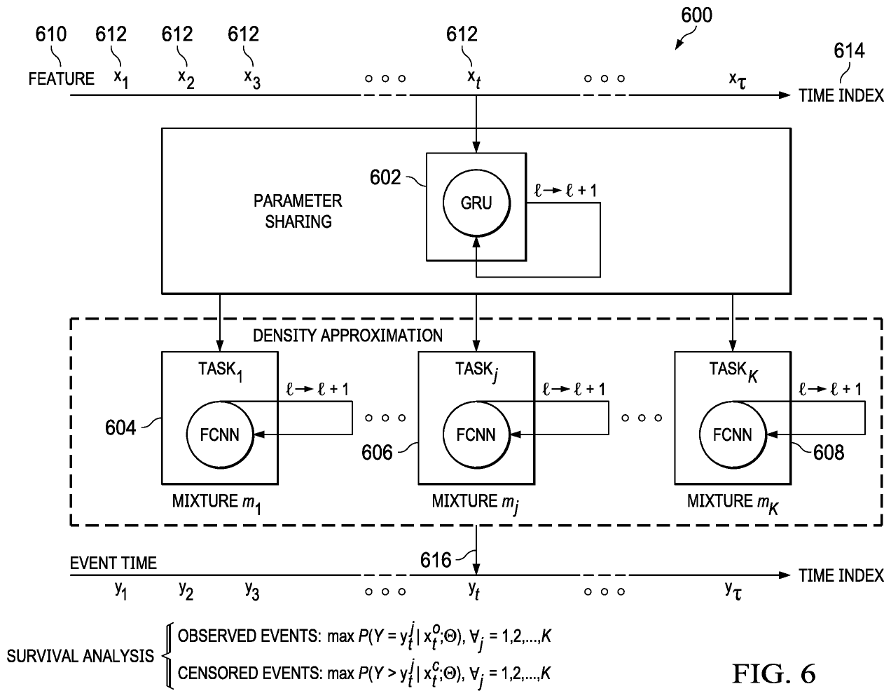

FIG. 6 depicts a multimodal, multi-task deep learning architecture in accordance with illustrative embodiments. Deep learning architecture 600 can be implemented through a combination of RNN 500 in FIG. 5 and neural network 400 in FIG. 4. Deep learning architecture 600 might be an example implementation of machine intelligence 204 in FIG. 2.

Deep learning architecture 600 comprises RNN 602 and three FCNN layer groups 604, 606, 608. By using multiple FCNN layer groups 604, 606, 608 on top of the RNN 602 layers, deep learning architecture 600 can approximate the density (distribution) of an event time. In particular, RNN 602 outputs the density parameters (e.g., mean and variance for the Gaussian distribution, or scale and shape parameters for the Weibull distribution). One simple distribution might not fit the underlying data very well. Therefore, illustrative embodiments can use a weighted combination of basis distributions to form the final output distribution. For the combination method, the illustrative embodiments can use the arithmetic average or geometric average. Once the density parameters are induced/outputted, the probability or density function for any given time can be computed, which is how the labeled sequence is used to compute the likelihood (or losses) to do backpropagation.

Multi-task learning can be used to predict a number of competitive benefits for an employee benefit plan of a particular business entity. In addition to classifying predicted changes over the different change categories, the multi-task learning can address the problem of forecasting competitive benefits. Based on the prediction/monitoring, for each business entity, the illustrative embodiments can predict a number of competitive benefits based on identified trends within the benefit plans and the employment data of the particular business entity, along with certain static attributes. The static attributes (features) such as, e.g., industry or sector, geographic location, jurisdiction, etc., can be used to segment or group business entities. Business entities that share static attributes are likely to have similar behaviors.

Input into deep learning architecture 600 comprises dynamic feature values 610 extracted at different timestamps 612 x₁, x₂, x₃, xₜ along a time index 614. The time intervals between timestamps 612 might be daily, weekly, monthly, etc.

The whole dataset used by RNN 602 represents changes to the benefit packages across all business entities within a time period. Each output only indicates a predicted change for a particular customer based on the observed data. However, prediction and inference of competitive benefits for a given customer relies both on past behavior of that business entity as well as change behavior of similar businesses. These (defined by shared static features). Therefore, the prediction output is an intelligent decision encoded with all changes across all events in the dataset.

In an illustrative embodiment, RNN 602 might comprise three layers (not shown). However, more layers can be used if needed. Each layer feeds into the next (similar to that shown in FIG. 5), denoted l−l+1 in FIG. 6. Within each RNN layer, the output of the previous timestamp is used as input for the next timestamp in the temporal sequence.

Deep learning architecture 600 comprises separate FCNN layer groups for each predicted competitive benefit. In the present example, three possible benefit changes are depicted. Therefore, there are three FCNN layer groups 604, 606, 608, one for each benefit change. Each FCNN might comprise multiple fully connected layers, as shown for example in FIG. 4.

RNN 602 shares all predicted change events to learn common representation. Then for each type of change event, an independent FCNN is used to learn how to make the prediction. A density/distribution modeling/approximation is attached to each FCNN layer groups 604, 606, 608. Specifically, density will output the density parameter(s). Assuming the output time sequence from RNN 602 follows the normal distribution, which has a mean parameter and a variance parameter, FCNN layer groups 604, 606, 608 can compute any probability density/distribution function or likelihood given any test time.

The final output vector 616 comprises a mixture of multiple distributions to determine the competitive benefit that captures the event information. In addition to a normal distribution there might also be Weibull distribution, an exponential distribution, etc. These probability density functions are combined together to produce one final weighted average. Each distribution will have a weight, which is determined automatically during the learning stage. The weighting is for each benefit. Using the example above, for FCNN 604 there will be multiple distributions for a particular benefit change attached with different weights. For FCNN 606, as well as with FCNN 608, there will be a similar kind of mixture behavior for the associated benefit change.

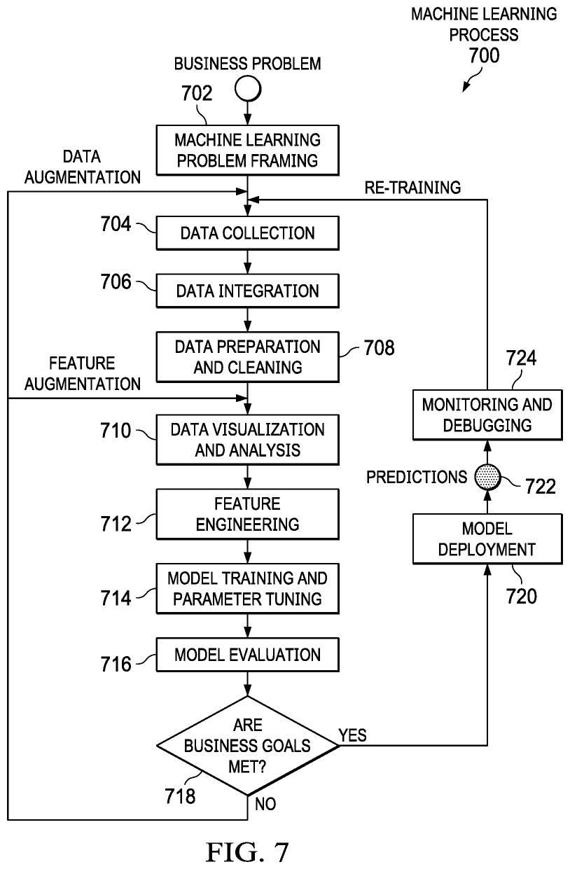

FIG. 7 depicts a flowchart illustrating a process for machine learning in accordance with illustrative embodiments. Process 700 might be an example implementation of machine learning 206 in FIG. 2. Process 700 begins with framing the machine learning problem (step 702). For example, the machine learning problem might be generating an employee benefit plan.

Data collection (step 704), data integration (step 706), and data preparation and cleaning (step 708) gather and organize the dataset of employment data and events used for machine learning.

After data preparation, process 700 proceeds to data visualization and analysis (step 710). This visualization might comprise a table, as well as other organizational schemes. Next, feature engineering is used to determine the features likely to have to the most predictive value (step 712).

The predictive model is then trained and tuned (step 714). This training might be carried out using a deep learning architecture such as deep learning architecture 600 in FIG. 6. The model is then evaluated for accuracy (step 716) and a determination is made as to whether the model meets the business goals (step 718). If the model fails the evaluation, process 700 might return to steps 704 and/or 710.

Once the model meets the business goals, it is ready for deployment (step 720). Predictions 722 made during normal operation are used for monitoring and debugging the model as a process of continuous re-training and refinement (step 724).

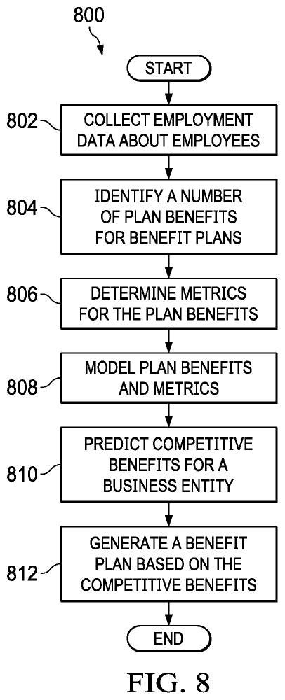

FIG. 8 depicts a flowchart for a process of predicting changes in employee benefits and generating an employee benefit plan in accordance with illustrative embodiments. Process 800 can be implemented using the computer systems and neural networks shown in FIGS. 2 and 6, for example.

Process 800 begins by collecting employment data about employees of a plurality of business entities (step 802). The employment data might comprise data about the business entities, static features/attributes of a business entity, dynamic features of a business entity, and timestamps of the dynamic features.

Process 800 identifies a number of plan benefits for benefit plan for each of the business entities (step 804). For example, a plan benefits may include employer-provided contributions or matching contributions to retirement plans, health insurance, and life insurance by any of the business entities, as changes to the plan benefits across different time periods.

Process 800 also determines metrics for the plan benefits during a given time interval (step 806). These metrics capture the amount of customer activity with regard to the plan benefits provided by the different benefit plans (i.e. dynamic features). In other words, how much are employees of the business entities using a particular feature. Such behavioral data might comprise, for example, product utilization (number of clicks, duration of use, wizard activity, downloads, page visits, calls to customer support, emails, chats, etc.

Using the identified plan benefits and the plan benefits metrics, process 800 simultaneously models the plan benefits and the metrics for plan benefits to identify correlations among the dimensions of data and generalize rules for competitive benefit prediction (step 808). In this example, the modeling in step 808 can be performed using multimodal multi-task learning such as that shown in FIGS. 6 and 7.

Based on this modeling, process 800 is able to predict a number of competitive benefits for an employee benefit plan of a particular business entity based on the employment data of the particular business entity (step 810).

Process 800 generates the employee benefit plan for the particular business entity based on the number of competitive benefits (step 812). After this process 800 ends.

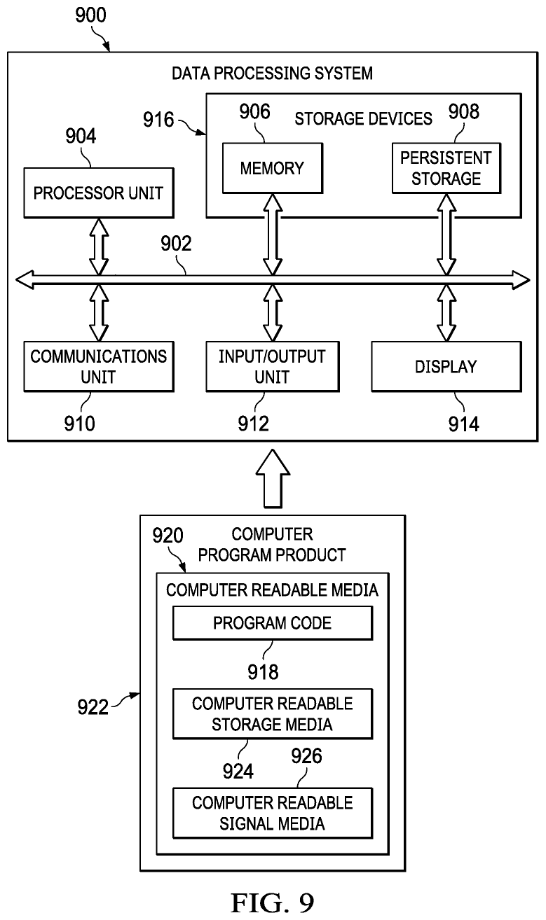

Turning now to FIG. 9, an illustration of a block diagram of a data processing system is depicted in accordance with an illustrative embodiment. Data processing system 900 may be used to implement one or more server computers and client computers in network data processing system 100 of FIG. 1. In this illustrative example, data processing system 900 includes communications framework 902, which provides communications between processor unit 904, memory 906, persistent storage 908, communications unit 910, input/output unit 912, and display 914. In this example, communications framework 902 may take the form of a bus system.

Processor unit 904 serves to execute instructions for software that may be loaded into memory 906. Processor unit 904 may be a number of processors, a multi-processor core, or some other type of processor, depending on the particular implementation. In an embodiment, processor unit 904 comprises one or more conventional general-purpose central processing units (CPUs). In an alternate embodiment, processor unit 904 comprises one or more graphical processing units (CPUs).

Memory 906 and persistent storage 908 are examples of storage devices 916. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 916 may also be referred to as computer-readable storage devices in these illustrative examples. Storage devices 916, in these examples, may be, for example, a random access memory or any other suitable volatile or non-volatile storage device. Persistent storage 908 may take various forms, depending on the particular implementation.

The term “non-transitory” or “tangible”, as used herein, is a limitation of the medium itself (i.e., tangible, not a signal) as opposed to a limitation on data storage persistency (e.g., RAM vs. ROM).

For example, persistent storage 908 may contain one or more components or devices. For example, persistent storage 908 may be a hard drive, a flash memory, a rewritable optical disk, a rewritable magnetic tape, or some combination of the above. The media used by persistent storage 908 also may be removable. For example, a removable hard drive may be used for persistent storage 908. Communications unit 910, in these illustrative examples, provides for communications with other data processing systems or devices. In these illustrative examples, communications unit 910 is a network interface card.

Input/output unit 912 allows for input and output of data with other devices that may be connected to data processing system 900. For example, input/output unit 912 may provide a connection for user input through at least one of a keyboard, a mouse, or some other suitable input device. Further, input/output unit 912 may send output to a printer. Display 914 provides a mechanism to display information to a user.

Instructions for at least one of the operating system, applications, or programs may be located in storage devices 916, which are in communication with processor unit 904 through communications framework 902. The processes of the different embodiments may be performed by processor unit 904 using computer-implemented instructions, which may be located in a memory, such as memory 906.

These instructions are referred to as program code, computer-usable program code, or computer-readable program code that may be read and executed by a processor in processor unit 904. The program code in the different embodiments may be embodied on different physical or computer-readable storage media, such as memory 906 or persistent storage 908.

Program code 918 is located in a functional form on computer-readable media 920 that is selectively removable and may be loaded onto or transferred to data processing system 900 for execution by processor unit 904. Program code 918 and computer-readable media 920 form computer program product 922 in these illustrative examples. In one example, computer-readable media 920 may be computer-readable storage media 924 or computer-readable signal media 926.

In these illustrative examples, computer-readable storage media 924 is a physical or tangible storage device used to store program code 918 rather than a medium that propagates or transmits program code 918. Alternatively, program code 918 may be transferred to data processing system 900 using computer-readable signal media 926.

Computer-readable signal media 926 may be, for example, a propagated data signal containing program code 918. For example, computer-readable signal media 926 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 900 are not meant to provide architectural limitations to the manner in which different embodiments may be implemented. The different illustrative embodiments may be implemented in a data processing system including components in addition to or in place of those illustrated for data processing system 900. Other components shown in FIG. 9 can be varied from the illustrative examples shown. The different embodiments may be implemented using any hardware device or system capable of running program code 918.

As used herein, the phrase “a number” means one or more. The phrase “at least one of”, when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item C. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

The illustrative embodiments provide method for generating an employee benefit plan. The method comprises collecting employment data about employees of a plurality of business entities, wherein the employment data comprises a number of dimensions of data collected from a number of sources. The method further comprises identifying a number of plan benefits for benefit plan for each of the business entities, and determining metrics for the plan benefits during a given time interval. From this data, the method simultaneously models the plan benefits and the metrics for plan benefits to identify correlations among the dimensions of data and generalize rules for competitive benefit prediction. The method then predicts, according the modeling, a number of competitive benefits for an employee benefit plan of a particular business entity based on the employment data of the particular business entity. The method then generates the employee benefit plan for the particular business entity based on the number of competitive benefits

By predicting both the competitive benefits and the trending changes among those benefits, the illustrative embodiments allow proactive steps to be taken to assist a business entity in making changes to attract or retain human capital assets. The anticipatory, proactive steps can provide cost and time savings for both business entities and service providers.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component. Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1.-21. (canceled)

22. A method, comprising:
aggregating, by a data processing system coupled with memory, a first data set from a first source and a second data set from a second source;
identifying, by the data processing system a first plan associated with the first source and a second plan associated with the second source;
identifying, by the data processing system, first characteristics for the first plan at a first time, second characteristics for the second plan at a second time, third characteristics for the first plan at a time different from the first time and fourth characteristics for the second plan at a time different than the second time;
determining, by the data processing system using the first data set, the first characteristics, and the third characteristics, a first metric associated with the first plan;
determining, by the data processing system using the second data set, the second characteristics, and the fourth characteristics, a second metric associated with the second plan;
identifying, by the data processing system, similarities between the first data set, the second data set, and a third data set from a third source;
determining, by the data processing system, correlations between the first plan and the second plan responsive to identifying the similarities;
generating target characteristics using a recurrent neural network having as inputs the determined correlations between the first plan and the second plan, the first metric, and the second metric;
generating a third plan using a fully connected neural network having as inputs the correlations, the target characteristics, and the third data set; and
transmitting, by the data processing system for display, the third plan.

23. The method of claim 22, comprising determining, by the data processing system, the first metric associated with the first plan and the second metric associated with the second plan by identifying differences between the first characteristics, the second characteristics, the third characteristics, and the fourth characteristics.

24. The method of claim 22, wherein the recurrent neural network comprises three layers.

25. The method of claim 22, comprising predicting, by the data processing system, the target characteristics using a recurrent neural network for each of the target characteristics.

26. The method of claim 22, comprising determining, by the data processing system using the recurrent neural network, probability distributions associated with the target characteristics using the first metric, the second metric, the first data set, and the second data set.

27. The method of claim 22, comprising generating, by the data processing system using the fully connected neural network, the third plan according to probability distributions associated with the target characteristics.

28. The method of claim 22, wherein the first data set, the second data set, and the third data set comprise at least one of: payroll services beginning date, a payroll services ending date, an industry, a geographic region, a number of employees, a collection of job codes, a range of salary amount, a range of part-time to full-time employees, hiring data, characteristics administration data, payroll data, performance review data, or team data.

29. The method of claim 22, wherein the first characteristics are different than the third characteristics and the second characteristics are different than the fourth characteristics.

30. The method of claim 22, wherein the third plan comprises a subset of the target characteristics.

31. A system, comprising a data processing system comprising a processor coupled with memory, the data processing system to:
aggregate a first data set from a first source and a second data set from a second source;
identify a first plan associated with the first source and a second plan associated with the second source;
identify first characteristics for the first plan at a first time, second characteristics for the second plan at a second time, third characteristics for the first plan at a time different from the first time and fourth characteristics for the second plan at a time different than the second time;
determine using the first data set, the first characteristics, and the third characteristics, a first metric associated with the first plan;
determine using the second data set, the second characteristics, and the fourth characteristics, a second metric associated with the second plan;
identify similarities between the first data set, the second data set, and a third data set from a third source;
determine correlations between the first plan and the second plan responsive to identifying the similarities;
generate target characteristics using a recurrent neural network having as inputs the determined correlations between the first plan and the second plan, the first metric, and the second metric;
generate a third plan using a fully connected neural network having as inputs the correlations, the target characteristics, and the third data set; and
transmit for display the third plan.
predict using a recurrent neural network, target characteristics based on the correlations, the first metric, and the second metric;
generate using a fully connected neural network, a third plan, using the correlations, the target characteristics, and the third data set; and
transmit the third plan to the third source for presentation on a display associated with the third source.

32. The system of claim 31, comprising the data processing system to determine the first metric associated with the first plan and the second metric associated with the second plan by identifying differences between the first characteristics, the second characteristics, the third characteristics, and the fourth characteristics.

33. The system of claim 31, wherein the recurrent neural network comprises three layers.

34. The system of claim 31, comprising the data processing system to predict the target characteristics using a recurrent neural network for each of the target characteristics.

35. The system of claim 31, comprising the data processing system to determine, using the recurrent neural network, probability distributions associated with the target characteristics using the first metric, the second metric, the first data set, and the second data set.

36. The system of claim 31, comprising the data processing system to generate, using the fully connected neural network, the third plan according to probability distributions associated with the target characteristics.

37. The system of claim 31, wherein the first data set, the second data set, and the third data set comprise at least one of: payroll services beginning date, a payroll services ending date, an industry, a geographic region, a number of employees, a collection of job codes, a range of salary amount, a range of part-time to full-time employees, hiring data, characteristics administration data, payroll data, performance review data, or team data.

38. The system of claim 31, wherein the first characteristics are different than the third characteristics and the second characteristics are different than the fourth characteristics.

39. A non-transitory computer-readable medium, comprising instructions embodied thereon, the instructions to cause a processor to:
aggregate a first data set from a first source and a second data set from a second source;
identify a first plan associated with the first source and a second plan associated with the second source;
identify first characteristics for the first plan at a first time, second characteristics for the second plan at a second time, third characteristics for the first plan at a time different from the first time and fourth characteristics for the second plan at a time different than the second time;
determine using the first data set, the first characteristics, and the third characteristics, a first metric associated with the first plan;
determine using the second data set, the second characteristics, and the fourth characteristics, a second metric associated with the second plan;
identify similarities between the first data set, the second data set, and a third data set from a third source;
determine correlations between the first plan and the second plan responsive to identifying the similarities;
generate target characteristics using a recurrent neural network having as inputs the determined correlations between the first plan and the second plan, the first metric, and the second metric;
generate a third plan using a fully connected neural network having as inputs the correlations, the target characteristics, and the third data set; and
transmit for display the third plan.

40. The non-transitory computer-readable medium of claim 39, comprising the instructions to cause the processor to determine the first metric associated with the first plan and the second metric associated with the second plan by identifying differences between the first characteristics, the second characteristics, the third characteristics, and the fourth characteristics.

41. The non-transitory computer-readable medium of claim 39, comprising the instructions to cause the processor to generate, using the fully connected neural network, the third plan according to probability distributions associated with the target characteristics.
